(19) United States
(12) Patent Application Publication
(10) Pub. No.: US 2013/0271810 A1
(43) Pub. Date: Oct. 17, 2013

(54) ILLUMINATION DEVICE, AND MICROSCOPE APPARATUS INCLUDING THE ILLUMINATION DEVICE

(71) Applicant: OLYMPUS CORPORATION, Tokyo (JP)

(72) Inventors: Eiji YOKOI, Tokyo (JP); Yasunari MATSUKAWA, Saitama (JP); Hiroshi SASAKI, Tokyo (JP)

(73) Assignee: OLYMPUS CORPORATION, Tokyo (JP)

(21) Appl. No.: 13/857,098

(22) Filed: Apr. 4, 2013

(30) Foreign Application Priority Data
Apr. 12, 2012 (JP) 2012-091308

(51) Int. Cl. G02B 21/06; G02F 1/01

(52) U.S. Cl. CPC G02B 21/06; G02F 1/01
USPC 359/238; 359/385

(57) ABSTRACT

An illumination device includes a phase-modulation type spatial light modulator that is arranged at a position optically conjugate to a pupil position of an illumination lens between a light source and the illumination lens for irradiating light emitted from the light source on a sample, and a pupil projecting optics system for projecting at least one area within the pupil of the illumination lens onto a plurality of different areas of the spatial light modulator.

### CROSS-REFERENCE TO RELATED APPLICATIONS

This application is based upon and claims the benefit of priority from the prior Japanese Patent Application No. 2012-091308, filed on Apr. 12, 2012, the entire contents of which are incorporated herein by this reference.

### BACKGROUND OF THE INVENTION

1. Field of the Invention

The present invention relates to an illumination device and a microscope apparatus including the illumination device, and more particularly, to an illumination device including a phase-modulation type spatial light modulator and a microscope apparatus including the illumination device.

2. Description of the Related Art

A fluorescence microscopy for elucidating a biofunction by combining fluorescence imaging and a sample operation (such as photo-activation, photo-conversion, a cellular function inhibition, or activation) using a light stimulation is known in neuro-chemical and electro-physiological fields.

Such a fluorescence microscopy demands a function of arbitrarily and quickly changing a light pattern (a shape, a size, the number of spot, an irradiation position) irradiated on a sample according to a sample or an application. The function of arbitrarily changing a light pattern irradiated on a sample can be realized by using a phase-modulation type spatial light modulator (SLM: hereinafter abbreviated to SLM) arranged at a position optically conjugate to a pupil position (hereinafter referred to as a pupil conjugate position) of an illumination lens such as an objective lens or the like. Such a technique is disclosed, for example, by Japanese Laid-open Patent Publication No. 2006-72280.

With an apparatus including a phase-modulation type SLM arranged at a pupil conjugate position of an illumination lens, the phase-modulation type SLM controls a wavefront by modulating a phase of incident light at the pupil conjugate position, so that an arbitrary light pattern can be formed on a sample plane via an illumination lens that functions as a Fourier transform lens. Moreover, an irradiation position in an optical axis direction of the illumination lens can be adjusted, and an aberration of the illumination lens can be corrected.

In the apparatus including the phase-modulation type SLM at the pupil conjugate position of the illumination lens, the phase-modulation type SLM alters a light pattern irradiated on a sample by changing a pattern (hereinafter referred to as a phase modulation pattern) identified with a state of each of pixels configuring the phase-modulation type SLM.

### SUMMARY OF THE INVENTION

A first aspect of the present invention provides an illumination device including a phase-modulation type spatial light modulator that is arranged at a position optically conjugate to a pupil position of the illumination lens between a light source and the illumination lens for irradiating light emitted from the light source on a sample, and a pupil projecting optics system for projecting at least one area within a pupil of the illumination lens onto a plurality of different areas of the spatial light modulator.

Another aspect of the present invention provides a microscope apparatus including the illumination lens, and the illumination device in the first aspect.

### BRIEF DESCRIPTION OF THE DRAWINGS

The present invention will be more apparent from the following detailed description when the accompanying drawings are referenced.

FIG. 1 illustrates an example of a configuration of an illumination device according to a first embodiment of the present invention;

FIG. 2 illustrates an example of a configuration of an illumination device according to a second embodiment of the present invention;

FIG. 3 illustrates an example of a configuration of an illumination device according to a third embodiment of the present invention;

FIG. 4A illustrates an example of a configuration of a microscope apparatus according to a fourth embodiment of the present invention;

FIG. 4B illustrates an example of a reflective LCOS (Liquid crystal on silicon) included in the microscope apparatus according to the fourth embodiment;

FIG. 5 illustrates an example of a configuration of a microscope apparatus according to a fifth embodiment of the present invention;

FIG. 6A illustrates an example of part of a configuration of an illumination device according to a sixth embodiment of the present invention;

FIG. 6B illustrates an example of a reflective LCOS included in the illumination device according to the sixth embodiment of the present invention;

FIG. 6C illustrates an example of a light pattern formed on a sample by the illumination device according to the sixth embodiment of the present invention;

FIG. 7A illustrates an example of a configuration of an illumination device according to a seventh embodiment of the present invention;

FIG. 7B illustrates an example of a reflective LCOS included in the illumination device according to the seventh embodiment of the present invention;

FIG. 8 illustrates an example of part of a configuration of an illumination device according to an eighth embodiment of the present invention;

FIG. 9A illustrates an example of a configuration of an illumination device according to a ninth embodiment of the present invention;

FIG. 9B illustrates an example of a reflective LCOS included in the illumination device according to the ninth embodiment of the present invention;

FIG. 9C illustrates light patterns formed on a sample by the illumination device according to the ninth embodiment of the present invention;

FIG. 10A illustrates an example of a configuration of an illumination device according to a tenth embodiment of the present invention;

FIG. 10B illustrates a state of light incident to a pupil of an objective lens when an optical path coupling unit included in the illumination device according to the tenth embodiment of the present invention is inserted to an optical path; and

FIG. 10C illustrates a state of light incident to the pupil of the objective lens when the optical path coupling unit included in the illumination device according to the tenth embodiment of the present invention is removed from the optical path.

### DESCRIPTION OF THE EMBODIMENTS

### First Embodiment

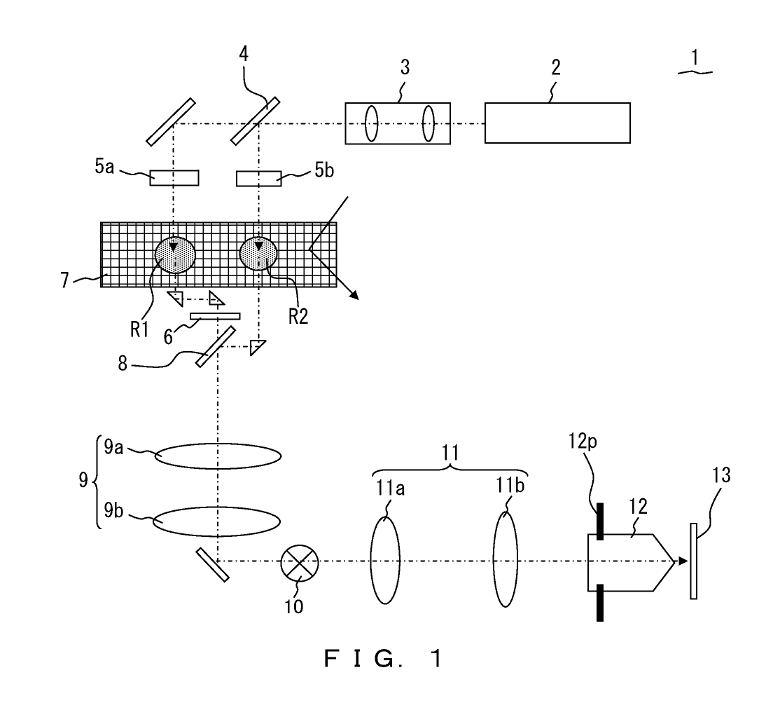

FIG. 1 illustrates an example of a configuration of an illumination device according to a first embodiment. The illumination device 1 illustrated in FIG. 1 is an illumination device that forms an arbitrary light pattern on a sample 13 by phase-modulating illumination light emitted from a light source 2 with a reflective LCOS 7 arranged at a position conjugate to a pupil of an objective lens 12.

The illumination device 1 includes the light source 2 for emitting illumination light, which is linearly polarized light, a beam expander 3 for changing a light flux diameter of the illumination light, a half mirror 4 for splitting the illumination light, acousto-optic tunable filters (hereinafter abbreviated to AOTFs 5a and 5b) respectively arranged on optical paths of the illumination lights split by the half mirror 4, the reflective LCOS 7 for modulating phases of the illumination lights, and a λ/2 plate 6 arranged on either of the optical paths of the illumination lights split by the half mirror 4.

The illumination device 1 further includes a polarization beam splitter (hereinafter abbreviated to PBS), which is optical path coupling unit, for coupling the optical paths of the illumination lights split by the half mirror 4, a pupil rely optics system 9 composed of a lens 9a and a lens 9b, a galvanomirror 10, which is scanning unit for scanning the sample 13, a pupil relay optics system 11 composed of lenses 11a and 11b, and an objective lens 12 for irradiating the illumination light on the sample 13.

Here, a pupil position 12p of the objective lens 12, the galvanomirror 10, and the reflective LCOS 7 mutually have an optically conjugate relationship. Namely, in the illumination device 1, the pupil relay optics system 9 is configured to project the reflective LCOS 7 onto the galvanomirror 10, whereas the pupil relay optics system 11 is configured to project the galvanomirror 10 onto the pupil of the objective lens 12.

The light source 2 is, for example, a laser. However, the light source 2 is not limited to a laser as far as it is a light source for emitting illumination light having coherency. For example, a combination of a lamp light source for emitting light of high intensity and a pinhole may be used instead of the laser.

The beam expander 3 is not limited to an element for changing the light flux diameter of the illumination light with a certain magnification. The beam expander 3 may be configured as a beam diameter varying optics system that varies a light flux diameter of illumination light with an arbitrary magnification. In this case, at least either of the lenses that configure the beam expander 3 is configured to move in an optical axis direction.

The half mirror 4 is means for splitting the illumination light so as to irradiate the illumination lights on a plurality of different areas (areas R1 and R2) within the reflective LCOS 7. A dichroic mirror may be used instead of the half mirror 4 if light having a plurality of wavelengths is emitted from the light source 2.

The AOTF 5a is configured to modulate the intensity of the illumination light to be modulated in the area R1 after the light has passed through the half mirror 4 so as to modulate the intensity, on the sample 13, of the illumination light phase-modulated in the area R1. In contrast, the AOTF 5b is configured to modulate the intensity of the illumination light to be modulated in the area R2 after the light has been reflected on the half mirror 4 so as to modulate the intensity, on the sample 13, of the illumination light phase-modulated in the area R2. Namely, the AOTF 5a and the AOTF 5b are intensity modulation units for modulating the intensities, on the sample 13, of the lights respectively modulated in the plurality of different areas (the areas R1 and R2) of the reflective LCOS 7. The AOTF 5a is an intensity modulation element made to correspond to the area R1, whereas the AOTF 5b is an intensity modulation element made to correspond to the area R2. Here, the intensity modulation also includes a complete shutoff of light. Accordingly, the AOTF 5a and the AOTF 5b also function as an optical shutter. The AOTF 5a and the AOTF 5b have a wavelength selection function in addition to the intensity modulation function. Accordingly, if light having a plurality of wavelengths is emitted from the light source 2, the AOTF 5a and the AOTF 5b may be used also as wavelength selection unit for selecting a desired wavelength. The AOTF 5a and the AOTF 5b are arranged between the light source 2 and the reflective LCOS 7. However, the AOTF 5a and the AOTF 5b may be arranged between the reflective LCOS 7 and the PBS 8.

The λ/2 plate 6 is polarization direction conversion means for converting a polarization direction by providing a phase difference of 180 degrees to the illumination light, which is linearly polarized light emitted from the light source 2. The λ/2 plate 6 is arranged on an optical path between the area R1 and the PBS 8, and acts only on the illumination light that passes through the half mirror 4 and is emitted from the area R1 in the illumination light split by the half mirror 4 as illustrated in FIG. 1. As a result, a polarization surface of the illumination light emitted from the area R1 and that of the illumination light emitted from the area R2 are orthogonal to each other. Thus, the illumination light can be efficiently used.

The reflective LCOS 7 is a phase-modulation type SLM, arranged at a position optically conjugate to a pupil position of the objective lens 12p between the light source 2 and the objective lens 12, for modulating a phase of incident light, and has a pixel structure composed of a plurality of pixels each of which independently modulates the phase of incident light. The reflective LCOS 7 can independently modulate the phase of the illumination light incident to each of the pixels by controlling a state of each of the pixels of the reflective LCOS 7, namely, by controlling a phase modulation pattern identified with the state of each of the pixels. Here, the reflective LCOS 7 is taken as an example of the phase-modulation type SLM arranged at the pupil conjugate position of the objective lens 12. However, the phase-modulation type SLM is not limited to a phase modulator using liquid crystal, and may be, for example, a deformable mirror or the like for causing a difference between optical path lengths by driving a mirror. Moreover, the phase-modulation type SLM is not limited to a reflective phase modulator, and may be a transmissive liquid crystal phase modulator (hereinafter referred to as a transmissive LCOS).

The PBS 8 is optical path coupling unit for coupling optical paths of the illumination lights respectively modulated in the plurality of areas (the areas R1 and R2) of the reflective LCOS 7. The PBS 8 is arranged at a position between the reflective LCOS 7 and the objective lens 12. More specifically, the PBS 8 efficiently couples the illumination light modulated in the area R1 and that modulated in the area R2 by using a difference between the polarization directions. Accordingly, the PBS 8 is the optical path coupling unit and light coupling unit. Here, the PBS 8 is taken as an example of the optical path coupling unit. However, the optical path coupling unit is not limited to the PBS 8, and may be, for example, a birefringent element.

The galvanomirror 10 is scanning unit for two-dimensionally scanning the sample 13 on an XY plane orthogonal to the optical axis of the objective lens 12. Here, the galvanomirror 10 is taken as an example of the scanning unit arranged at the pupil conjugate position of the objective lens 12. However, the scanning unit is not limited to the galvanomirror 10, and may be, for example, an acoustic optical deflector (AOD) or the like.

The pupil relay optics system 9 and the pupil relay optics system 11 are optics systems for projecting the pupil of the objective lens 12 onto the reflective LCOS 7. The pupil of the objective lens 12 is respectively projected onto the areas R1 and R2 of the reflective LCOS 7 by adding the PBS 8, which is the optical path coupling unit. Namely, the PBS 8, the pupil relay optics system 9 and the pupil relay optics system 11 are a pupil projecting optics system for projecting the pupil of the objective lens 12 onto a plurality of different areas (the areas R1 and R2) of the reflective LCOS 7.

In the illumination device 1 configured as described above, the illumination light, which is linearly polarized light emitted from the light source 2, is split by the half mirror 4 after a light flux diameter of the illumination light is adjusted by the beam expander 3 in accordance with the pupil diameter of the objective lens 12. One of the split illumination lights is phase-modulated in the area R1 of the reflective LCOS 7 to which the light is incident via the AOTF 5a, whereas the other is phase-modulated in the area R2 of the reflective LCOS 7 to which the light is incident via the AOTF 5b. The illumination light that is phase-modulated in the area R1 passes through the λ/2 plate 6, and a polarization surface of the light is orthogonal to the polarization surface of the illumination light that is phase-modulated in the area R2. Therefore, the illumination lights are coupled by the PBS 8. Thereafter, the illumination lights respectively phase-modulated in the areas (the areas R1 and R2) are incident to the objective lens 12 via the pupil relay optics system 9, the galvanomirror 10, and the pupil relay optics system 11. The objective lens 12 forms, on the sample 13, a light pattern obtained by performing a Fourier transform for a phase modulation pattern formed in the area R1 from the illumination light phase-modulated in the area R1, and also forms, on the sample 13, a light pattern obtained by performing a Fourier transform for a phase modulation pattern formed in the area R2 from the illumination light phase-modulated in the area R2.

Accordingly, in the illumination device 1, a state (first state) where the illumination light is irradiated only on the area R1, a state (second state) where the illumination light is irradiated only on the area R2, and a state (third state) where the illumination light is irradiated on both of the areas R1 and R2 are switched by controlling the AOTF 5a and the AOTF 5b, and also a light pattern on the sample 13 is switched. Specifically, the light pattern obtained by performing the Fourier transform for the phase modulation pattern formed in the area R1 is formed on the sample 13 in the first state, the light pattern obtained by performing the Fourier transform for the phase modulation pattern formed in the area R2 is formed on the sample 13 in the second state, and a pattern where the light pattern obtained by performing the Fourier transform for the phase modulation pattern formed in the area R1 and the light pattern obtained by performing the Fourier transform for the phase modulation pattern formed in the area R2 overlap is formed on the sample 13 in the third state.

With the illumination device 1, an area of the reflective LCOS 7 projected by the illumination light on the sample 13 is switched by controlling the AOTF 5a and the AOTF 5b that run faster than the reflective LCOS 7, whereby the three light patterns can be switched without changing a phase modulation pattern of the reflective LCOS 7. Accordingly, the amount of data that the reflective LCOS 7 needs to form the three light patterns can be reduced to one third of conventional techniques, and light patterns can be irradiated on the sample 13 at least three times faster than the conventional techniques. Moreover, if only these three patterns are switched and used, it is not needed to make the reflective LCOS 7 run to switch between the phase modulation patterns thereafter by once forming the phase modulation patterns on the reflective LCOS 7. Accordingly, the light patterns can be switched at high speed without imposing any constraints on the running speed of the reflective LCOS 7. Therefore, with the illumination device 1, a light pattern irradiated on the sample can be arbitrarily and quickly changed.

Additionally, in the illumination device 1, light patterns are controlled by the reflective LCOS 7, which is a phase-modulation type SLM. Therefore, light can be used more efficiently than in a case where light patterns are controlled by an intensity-modulation type SLM such as a digital mirror device or the like. Moreover, in the illumination device 1, the beam expander 3 is configured as a beam diameter varying optics system, so that a light flux diameter of illumination light irradiated on the reflective LCOS 7 can be adjusted. Accordingly, even if an objective lens having a different pupil diameter is used, a light flux diameter of illumination light can be varied to fill the pupil of the objective lens. As a result, bright illumination can be realized regardless of an objective lens.

For the illumination device 1, the example where the two areas of the reflective LCOS 7 are projected onto the pupil of the objective lens 12 has been described. However, three or more area of the reflective LCOS 7 may be projected onto the pupil of the objective lens 12.

### Second Embodiment

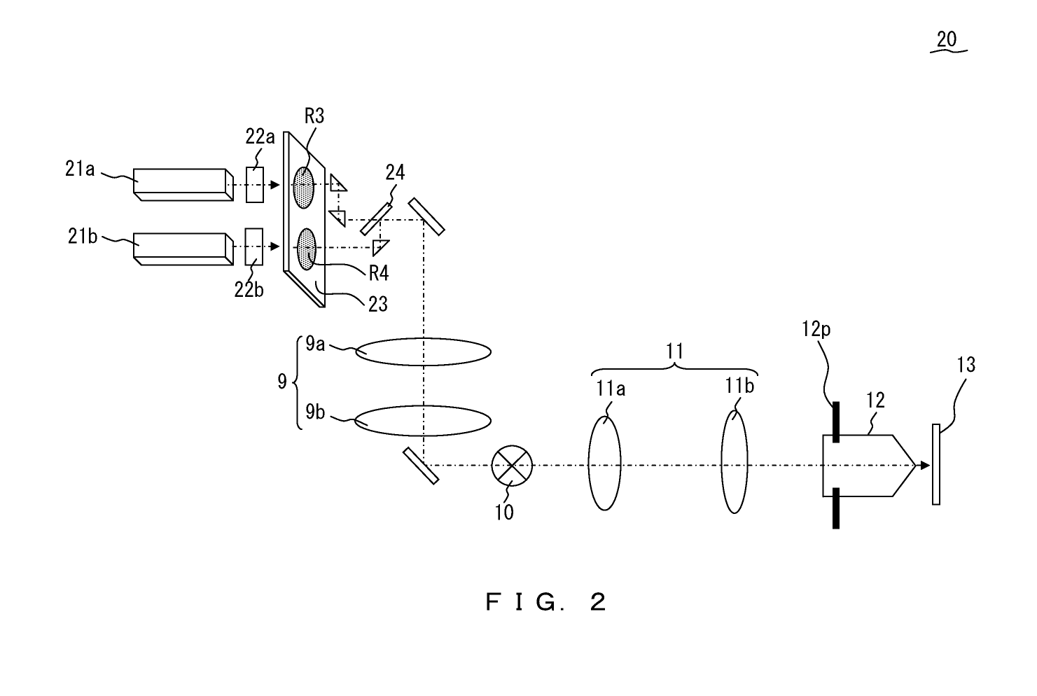

FIG. 2 illustrates an example of a configuration of an illumination device according to a second embodiment. The illumination device 20 illustrated in FIG. 2 is an illumination device that forms an arbitrary light pattern on a sample 13 by phase-modulating illumination lights emitted from light sources (a light source 21a and a light source 21b) with a transmissive LCOS 23 arranged at a position conjugate to a pupil of an objective lens 12.

The illumination device 20 is different from the illumination device 1 illustrated in FIG. 1 in that the illumination device 20 includes the plurality of light sources (the light source 21a and the light source 21b), includes the transmissive LCOS 23 instead of the reflective LCOS 7, and further includes a dichroic mirror 24 as optical path coupling unit instead of the PBS 8. Other components are similar to those of the illumination device 1 illustrated in FIG. 1. In FIG. 2, the same components as those of the illumination device 1 are denoted with the same reference numerals. In the illumination device 20, a beam expander is omitted for simplification of an explanation. However, the illumination device 20 may include a beam expander between the light sources and the transmissive LCOS 23 similarly to the illumination device 1 illustrated in FIG. 1.

In the illumination device 20 configured as described above, illumination light emitted from the light source 21a is phase-modulated in an area R3 of the transmissive LCOS 23 to which the light is incident via the AOTF 22a, and illumination light emitted from the light source 21b is phase-modulated in an area R4 of the transmissive LCOS 23 to which the light is incident via the AOTF 22b. Since the illumination light emitted from the light source 21a and that emitted from the light source 21b respectively have different wavelengths, they are coupled by the dichroic mirror 24. Thereafter, the illumination lights respectively phase-modulated in the areas (the area R3 and the area R4) are incident to the objective lens 12 via the pupil relay optics system 9, the galvanomirror 10, and the pupil relay optics system 11. The objective lens 12 forms, on the sample 13, a light pattern obtained by performing a Fourier transform for a phase modulation pattern formed in the area R3 from the illumination light phase-modulated in the area R3, and also forms, on the sample 13, a light pattern obtained by performing a Fourier transform for a phase modulation pattern formed in the area R4 from the illumination light phase-modulated in the area R4.

Accordingly, in the illumination device 20, a state (first state) where the illumination light is irradiated only on the area R3, a state (second state) where the illumination light is irradiated only on the area R4, and a state (third state) where the illumination light is irradiated on both of the areas R3 and R4 are switched by controlling the AOTF 22a and the AOTF 22b, and also a light pattern formed on the sample 13 is switched. Specifically, the light pattern obtained by performing the Fourier transform for the phase modulation pattern formed in the area R3 is formed on the sample 13 in the first state, the light pattern obtained by performing the Fourier transform for the phase modulation pattern formed in the area R4 is formed on the sample 13 in the second state, and a pattern where the light pattern obtained by performing the Fourier transform for the phase modulation pattern formed in the area R3 and that obtained by performing the Fourier transform for the phase modulation pattern formed in the area R4 overlap is formed on the sample 13 in the third state.

With the illumination device 20, a light pattern irradiated on the sample can be arbitrarily and quickly changed similarly to the illumination device 1 illustrated in FIG. 1. Moreover, the illumination device 20 is similar to the illumination device 1 in that the illumination device 20 can more efficiently use light than in a case where light patterns are controlled by an intensity-modulation type SLM such as a digital mirror device or the like.

Also for the illumination device 20, the example where the two areas of the transmissive LCOS 23 are projected onto the pupil of the objective lens 12 has been described. However, three or more areas of the transmissive LCOS 23 may be projected onto the pupil of the objective lens 12. Moreover, the dichroic mirror 24 is taken as an example of the optical path coupling unit for the illumination device. However, the optical path coupling unit is not limited to the dichroic mirror 24, and may be, for example, a λ/2 plate and a birefringent element.

### Third Embodiment

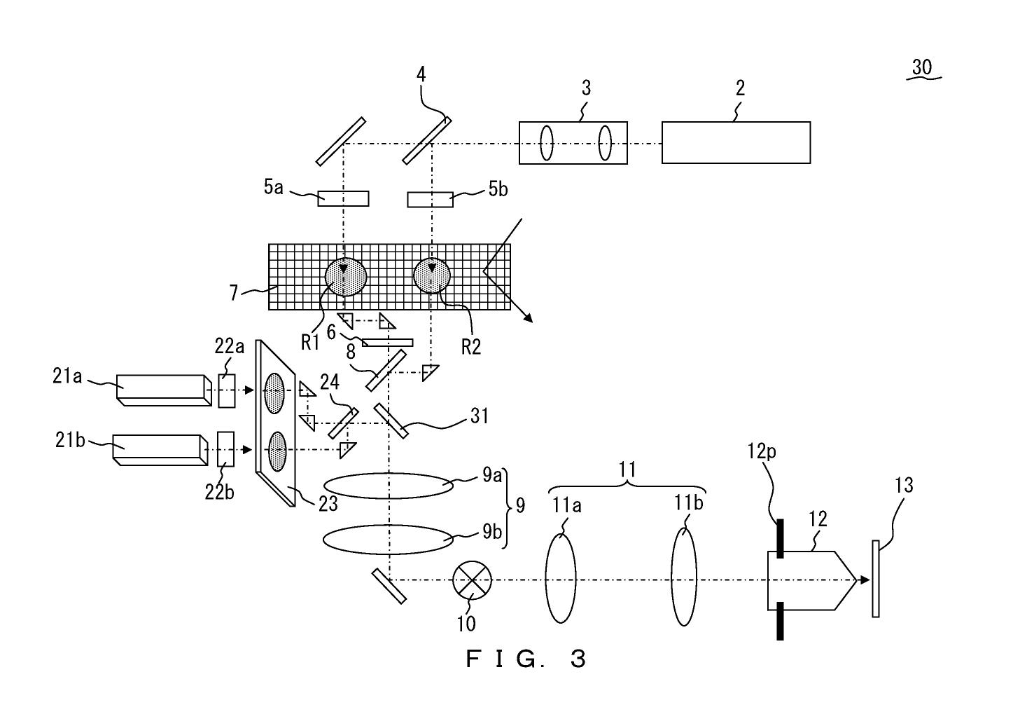

FIG. 3 illustrates an example of a configuration of an illumination device according to a third embodiment. The illumination device 30 illustrated in FIG. 3 is an illumination device that forms an arbitrary light pattern on the sample 13 by phase-modulating the illumination light emitted from the light source 2 with the reflective LCOS 7 arranged at the position conjugate to the pupil of the objective lens 12, and by phase-modulating the illumination lights emitted from the light sources 21a and 21b with the transmissive LCOS 23 arranged at the position conjugate to the pupil of the objective lens 12.

The illumination device 30 is an illumination device implemented by combining the illumination device 1 illustrated in FIG. 1 and the illumination device 20 illustrated in FIG. 2. In the illumination device 30, the illumination light phase-modulated by the reflective LCOS 7 and that phase-modulated by the transmissive LCOS 23 are coupled by a dichroic mirror 31 since wavelengths of the illumination lights emitted from the light sources (the light source 2, the light source 21a, and the light source 21b) are different. Namely, in the illumination device 30, the PBS 8, the dichroic mirror 24, and a dichroic mirror 31 function as optical path coupling unit.

In the illumination device 30, irradiation of the illumination lights onto the areas R1 to R4 is arbitrarily controlled by controlling the AOTF 5a, the AOTF 5b, the AOTF 22a, and the AOTF 22b, so that a total of 15 (=₄C₁+₄C₂+₄C₃+₄C₄) states are switched, and a light pattern according to each of the states is formed on the sample 13.

With the illumination device 30, a light pattern irradiated on the sample can be changed more arbitrarily and quickly than the illumination device 1 illustrated in FIG. 1 and the illumination device 20 illustrated in FIG. 2. Other effects are similar to those of the illumination device 1 and the illumination device 20.

### Fourth Embodiment

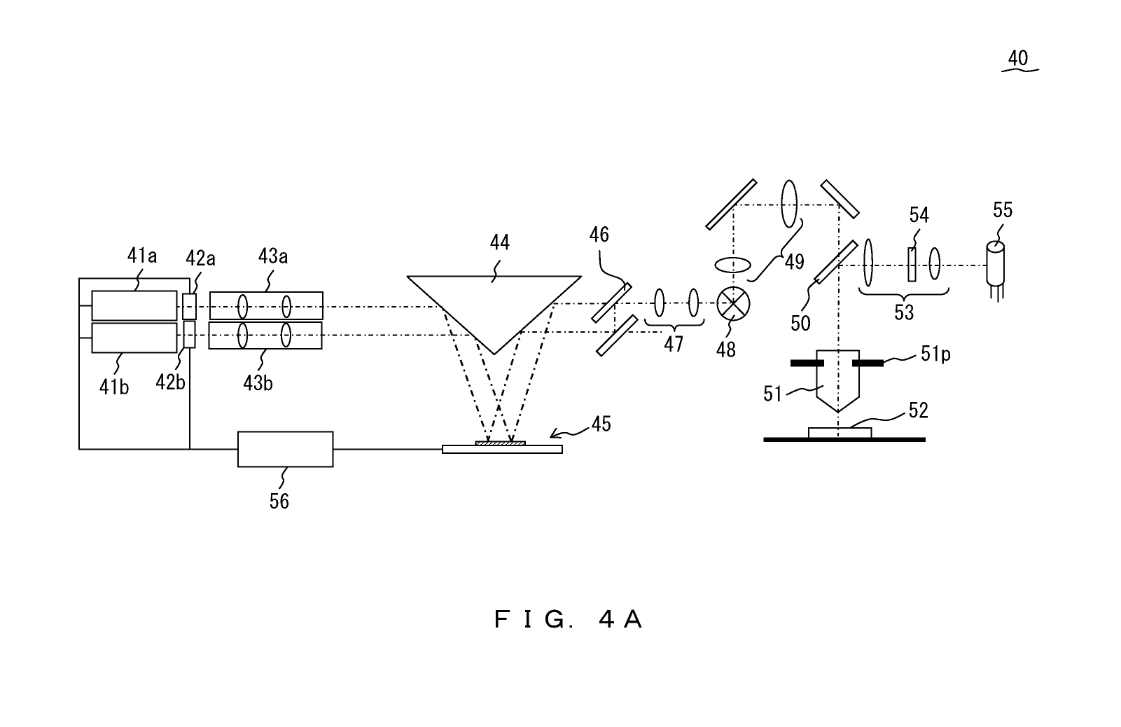

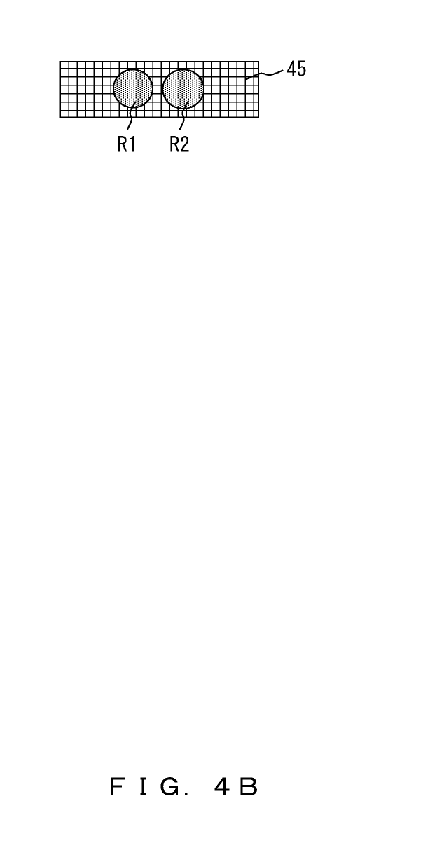

FIG. 4A illustrates an example of a configuration of a microscope apparatus according to a fourth embodiment. FIG. 4B illustrates an example of a reflective LCOS included in the microscope apparatus according to this embodiment. The microscope apparatus 40 illustrated in FIG. 4A is a laser-scanning type microscope apparatus that forms an arbitrary light pattern on a sample 52 by phase-modulating laser lights emitted from light sources (a titan-sapphire laser 41a and a titan-sapphire laser 41b) with the reflective LCOS 45 arranged at a position conjugate to a pupil of an objective lens 51, and observes the sample 52 by detecting fluorescence light from the sample 52 excited with the laser light. Namely, the microscope apparatus 40 is a laser-scanning type microscope apparatus including the illumination device that forms an arbitrary light pattern.

The microscope apparatus 40 includes the titan-sapphire lasers 41a and 41b for emitting laser lights (illumination lights) having different wavelengths, AOTFs 42a and 42b arranged respectively on optical paths of the laser lights emitted from the titan-sapphire lasers 41a and 41b, beam expanders 43a and 43b, respectively arranged on the optical paths of the laser lights emitted from the titan-sapphire lasers 41a and 41b, a prism 44 for reflecting the laser lights on the reflective LCOS 45, and the reflective LCOS 45 for modulating phases of the laser lights.

The microscope apparatus 40 further includes a dichroic mirror 46, which is optical path coupling unit for coupling the optical paths of the laser lights emitted from the titan-sapphire lasers 41a and 41b, a pupil relay optics system 47, a galvanomirror 48, which is scanning unit, for scanning the sample 52, a pupil relay optics systems 49, a dichroic mirror 50 for making the laser light pass through and reflecting the fluorescence light from the sample 52, and an objective lens 51 for irradiating the laser light on the sample 52.

The microscope apparatus 40 includes a pupil relay optics system 53, an IR cut filter 54 for shutting off light having a wavelength of an infrared range, and a photomultiplier 55 (hereinafter abbreviated to PMT), which is a photodetector, for converting the fluorescence light into an electric signal.

The microscope apparatus 40 further includes a control unit 56 electrically connected to at least the titan-sapphire laser 41a, the titan-sapphire laser 41b, the AOTF 42a, the AOTF 42b, and the reflective LCOS 45. The control unit 56 controls operations of these connected elements.

Here, a pupil position 51p of the objective lens 51, the galvanomirror 48, and the reflective LCOS 45 mutually have an optically conjugate relationship. Namely, in the microscope apparatus 40, the pupil relay optics system 47 is configured to project the reflective LCOS 45 onto the galvanomirror 48, whereas the pupil relay optics system 49 is configured to project the galvanomirror 48 onto the pupil of the objective lens 51. Moreover, it is preferable that the pupil position 51p of the objective lens 51 and the PMT 55 have a nearly optically conjugate relationship. As a result, in the microscope apparatus 40, the PMT 55 can detect fluorescence light occurring from an arbitrary area of the sample 52.

Other light sources for emitting illumination lights having coherency may be used instead of the titan-sapphire laser 41a and the titan-sapphire laser 41b. For example, a combination of a lamp light source for emitting light of high intensity and a pinhole may be used.

The AOTF 42a is configured to modulate the intensity of the laser light to be modulated in the area R1 so as to modulate the intensity, on the sample 52, of the laser light phase-modulated in the area R1 of the reflective LCOS 45 illustrated in FIG. 4B. In contrast, the AOTF 42b is configured to modulate the intensity of the laser light to be modulated in the area R2 so as to modulate the intensity, on the sample 52, of the laser light phase-modulated in the area R2 of the reflective LCOS 45 illustrated in FIG. 4B. Namely, the AOTF 42a and the AOTF 42b are intensity modulation units for modulating an intensity, on the sample 52, of the lights respectively modulated in the plurality of different areas (the area R1 and the area R2) of the reflective LCOS 45. Here, the intensity modulation also includes a complete shutoff of light. Accordingly, the AOTF 42a and the AOTF 42b also function as an optical shutter. Note that the AOTF 42a and the AOTF 42b also have a wavelength selection function in addition to the intensity modulation function. Accordingly, if light having a plurality of wavelengths is emitted from the titan-sapphire laser 41a and the titan-sapphire laser 41b, the AOTF 42a and the AOTF 42b may be used as wavelength selection unit for selecting a desired wavelength.

The beam expander 43a and the beam expander 43b are not limited to an element for changing the light flux diameter of laser light with a certain magnification, and may be configured as a beam diameter varying optics system for changing the light flux diameter of laser light with an arbitrary magnification. In this case, at least one of lenses that configure each of the beam expander 43a and the beam expander 43b is configured to move in an optical axis direction.

The reflective LCOS 45 is a phase-modulation type SLM, arranged at a position optically conjugate to the pupil position 51p between the light sources (the titan-sapphire laser 41a and the titan-sapphire laser 41b) and the objective lens 51, for modulating a phase of incident light, and has a pixel structure composed of a plurality of pixels each of which independently modulates the phase of incident light. By controlling a phase modulation pattern identified with a state of each of the pixels of the reflective LCOS 45, the reflective LCOS 45 can independently modulate the phase of illumination light incident to each of the pixels. Here, the reflective LCOS 45 is taken as an example of the phase-modulation type SLM arranged at the pupil conjugate position of the objective lens 51. However, the phase-modulation type SLM is not limited to a phase modulator using liquid crystal, and may be, for example, a deformable mirror that causes a difference between optical path lengths by driving a mirror. Moreover, the phase-modulation type SLM is not limited to a reflective phase modulator, and may be a transmissive liquid crystal phase modulator (hereinafter abbreviated to a transmissive LCOS).

The dichroic mirror 46 is optical path coupling unit for coupling optical paths of laser lights respectively modulated in the plurality of areas (the area R1 and the area R2) of the reflective LCOS 45 arranged between the reflective LCOS 45 and the objective lens 51. More specifically, the dichroic mirror 46 couples the laser light modulated in the area R1 and that modulated in the area R2 by using a difference between wavelengths of the laser lights respectively modulated in the areas R1 and R2. Accordingly, the dichroic mirror 46 is optical path coupling unit and light coupling unit. If the titan-sapphire laser 41a and the titan-sapphire laser 41b emit polarized lights having different polarization directions, a PBS may be used as optical path coupling unit instead of the dichroic mirror 46.

The galvanomirror 48 is scanning unit for two-dimensionally scanning the sample 52 on an XY plane orthogonal to the optical axis of the objective lens 51. Here, the galvanomirror 48 is taken as an example of the scanning unit arranged at the pupil conjugate position of the objective lens 51. However, the scanning unit is not limited to the galvanomirror 48, and may be, for example, an acoustic optical deflector (AOD) or the like.

The pupil relay optics system 47 and the pupil relay optics system 49 are optics systems for projecting the pupil of the objective lens 51 onto the reflective LCOS 45. By adding the dichroic mirror 46, which is optical path coupling unit, the pupil of the objective lens 51 is respectively projected onto the area R1 and the area R2 of the reflective LCOS 45. Namely, the dichroic mirror 46, the pupil relay optics system 47, and the pupil relay optics system 49 are a pupil projecting optics system for projecting the pupil of the objective lens 51 onto the plurality of different areas (the area R1 and the area R2) of the reflective LCOS 45.

In the microscope apparatus 40 configured as described above, the laser light emitted from the titan-sapphire laser 41a is reflected on the prism 44 after a light flux diameter of the light is adjusted by the beam expander 43a to which the light is incident via the AOTF 42a in accordance with the pupil diameter of the objective lens 51, incident to the area R1 of the reflective LCOS 45, and phase-modulated. In contrast, the laser light emitted from the titan-sapphire laser 41b is reflected on the prism 44 after a light flux diameter of the light is adjusted by the beam expander 43b to which the light is incident via the AOTF 42b in accordance with the pupil diameter of the objective lens 51, incident to the area R2 of the reflective LCOS 45, and phase-modulated.

Since a wavelength of the laser light phase-modulated in the area R1 is different from that of the laser light phase-modulated in the area R2, they are coupled by the dichroic mirror 46. Thereafter, the laser lights respectively phase-modulated in the areas (the area R1 and the area R2) are incident to the objective lens 51 via the pupil relay optics system 47, the galvanomirror 48, the pupil relay optics system 49, and the dichroic mirror 50. The objective lens 51 forms, on the sample 52, a light pattern obtained by performing a Fourier transform for a phase modulation pattern formed in the area R1 from the laser light phase-modulated in the area R1, and also forms, on the sample 52, a light pattern obtained by performing a Fourier transform for a phase modulation pattern formed in the R2 from the laser light phase-modulated in the area R2.

The sample 52 on which the laser light is irradiated emits fluorescence light since a fluorescent substance contained in the sample 52 is excited. The fluorescence light emitted from the sample 52 is reflected on the dichroic mirror 50 to which the light is incident via the objective lens 51, and incident to the PMT 55 via the pupil relay optics system 53. At this time, laser light having a wavelength of an infrared range is shut off by passing through the IR filter 54.

In the microscope apparatus 40, a state (first state) where the laser light is irradiated only on the area R1, a state (second state) where the laser light is irradiated only on the area R2, and a state (third state) where the laser light is irradiated on both of the areas R1 and R2 are switched by controlling the AOTF 42a and the AOTF 42b, and also a light pattern on the sample 52 is switched. Specifically, the light pattern obtained by performing the Fourier transform for the phase modulation pattern formed in the area R1 is formed on the sample 52 in the first state, the light pattern obtained by performing the Fourier transform for the phase modulation pattern formed in the area R2 is formed on the sample 52 in the second state, and a pattern where the light pattern obtained by performing the Fourier transform for the phase modulation pattern formed in the area R1 and the light pattern obtained by performing the Fourier transform for the phase modulation pattern formed in the area R2 overlap is formed on the sample 52 in the third state.

With the microscope apparatus 40, the sample 52 is observed, and a light pattern irradiated on the sample can be arbitrarily and quickly changed similarly to the illumination device 1 illustrated in FIG. 1. Moreover, the microscope apparatus 40 is similar to the illumination device 1 in that the microscope apparatus 40 can more efficiently use light than in a case where light patterns are controlled by an intensity modulation type SLM such as a digital mirror device or the like and brighter illumination can be realized regardless of an objective lens.

For the microscope apparatus 40, the example where the two areas of the reflective LCOS 45 are projected onto the pupil of the objective lens 51 is described. However, three or more areas of the reflective LCOS 45 may be projected onto the pupil of the objective lens 51.

### Fifth Embodiment

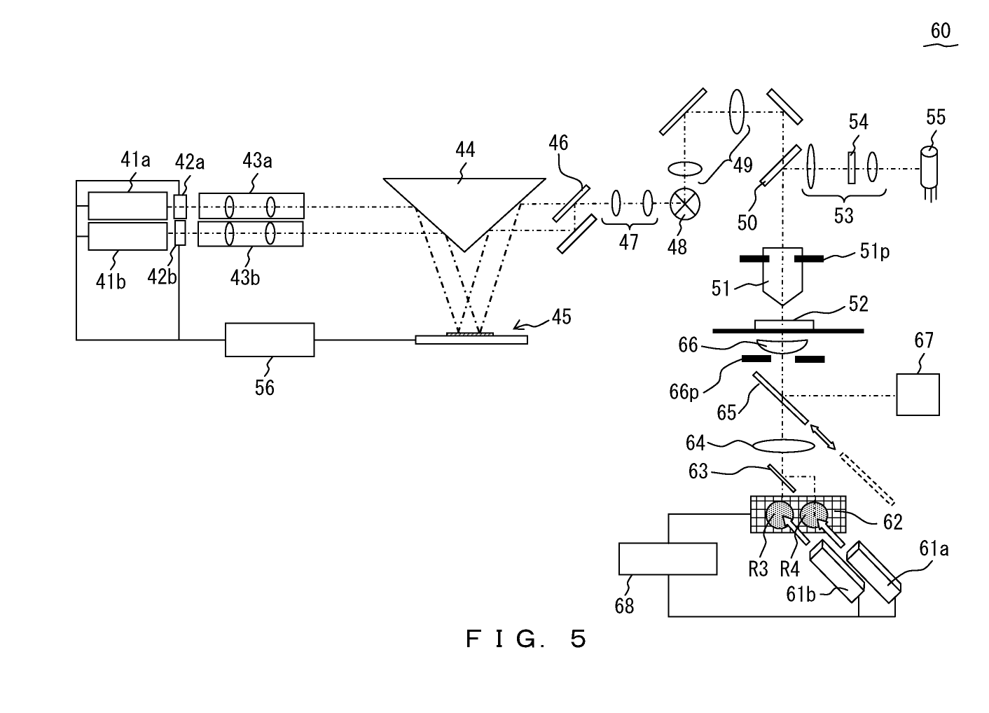

FIG. 5 illustrates an example of a configuration of a microscope apparatus according to a fifth embodiment. The microscope apparatus 60 illustrated in FIG. 5 forms an arbitrary light pattern on the sample 52 by phase-modulating the laser lights emitted from the light sources (the titan-sapphire laser 41a and the titan-sapphire laser 41b) with the reflective LCOS 45 arranged at the position conjugate to the pupil of the objective lens 51, and also forms an arbitrary light pattern on the sample 52 by phase-modulating laser lights emitted from light sources (a laser diode 61a and a laser diode 61b) with a deformable mirror 62 arranged at a position conjugate to a pupil of a condenser lens 66. Moreover, the microscope apparatus 60 observes the sample 52 by detecting fluorescence light from the sample 52 excited with the laser light. Namely, the microscope apparatus 60 is a laser-scanning type microscope apparatus including an illumination device that forms an arbitrary light pattern.

The microscope apparatus 60 is different from the microscope apparatus 40 illustrated in FIG. 4A in that the microscope apparatus 60 includes a transmissive illumination device. Other components are similar to those of the microscope apparatus 40 illustrated in FIG. 4A. In FIG. 5, the same components as those of the microscope apparatus 40 are denoted with the same reference numerals.

The transmissive illumination device of the microscope apparatus 60 includes, as illustrated in FIG. 5, the laser diodes (the laser diode 61a and the laser diode 61b) for emitting laser lights (illumination lights) having different wavelengths, the deformable mirror 62 for modulating phases of the laser lights, a dichroic mirror 63 for coupling the laser lights respectively phase-modulated in the areas R3 and R4 of the deformable mirror 62, a lens 64 for projecting the areas R3 and R4 respectively onto the pupil of the condenser lens 66, a mirror 65 arranged to be freely insertable/removable to/from an optical axis of the condenser lens 66, a halogen light source 67, and a control unit 68 for controlling at least the laser diodes and the deformable mirror 62.

The deformable mirror 62 is a phase-modulation type SLM, arranged between the laser diodes (the laser diode 61a and the laser diode 61b) and the condenser lens 66 at a position optically conjugate to a pupil position 66p of the condenser lens 66, for modulating a phase of incident light, and has a pixel structure composed of a plurality of pixels each of which independently modulates the phase of incident light.

By inserting/removing the mirror 65 to/from the optical axis of the condenser lens 66, a state where light emitted from the halogen light source 67 is irradiated on the sample 52 and a state where lights emitted from the laser diodes (the laser diode 61a and the laser diode 61b) are irradiated on the sample 52 can be switched.

In the laser diodes, outputs of the lasers can be freely changed according to a control performed by the control unit 68. Accordingly, an optical element having a shutter function, such as an AOTF or the like, is omitted in the transmissive illumination device.

In the microscope apparatus 60, a total of 15 (=₄C₁+₄C₂+₄C₃+₄C₄) states are switched by arbitrarily controlling irradiation of the illumination lights on the areas R1 to R4 with a control of the AOTF 42a, the AOTF 42b, the laser diode 61a and the laser diode 61b, so that a light pattern according to each of the states is formed on the sample 52.

With the microscope apparatus 60, a light pattern irradiated on the sample can be more arbitrarily and quickly changed than the microscope apparatus 40 illustrated in FIG. 4A. Other effects are similar to those of the microscope apparatus 40.

### Sixth Embodiment

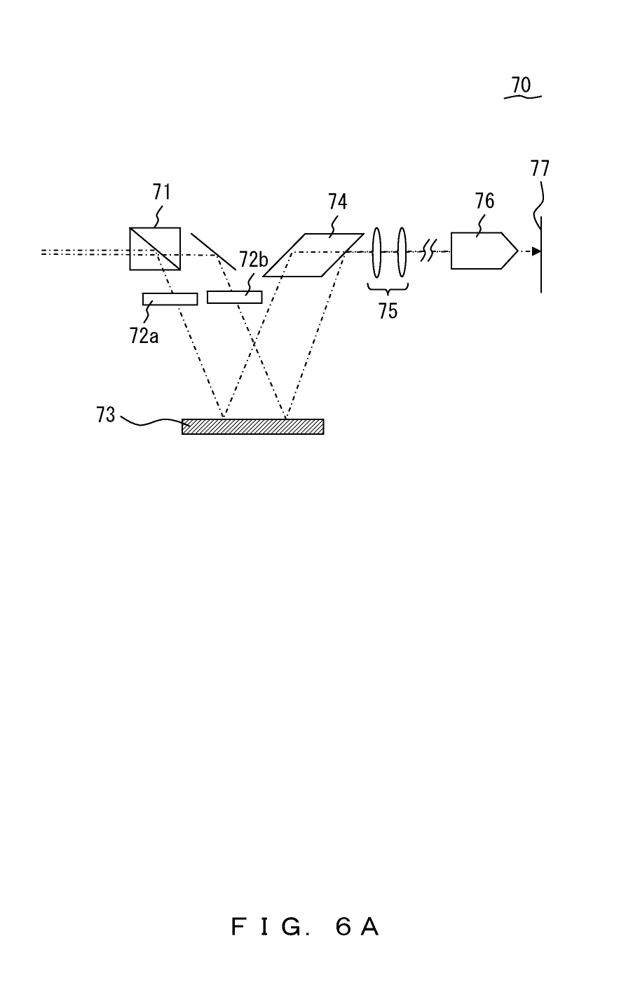

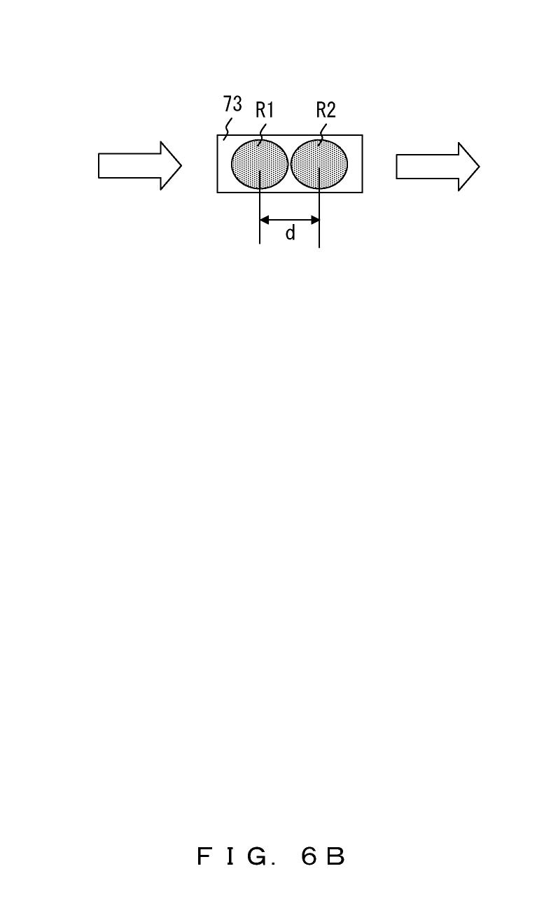

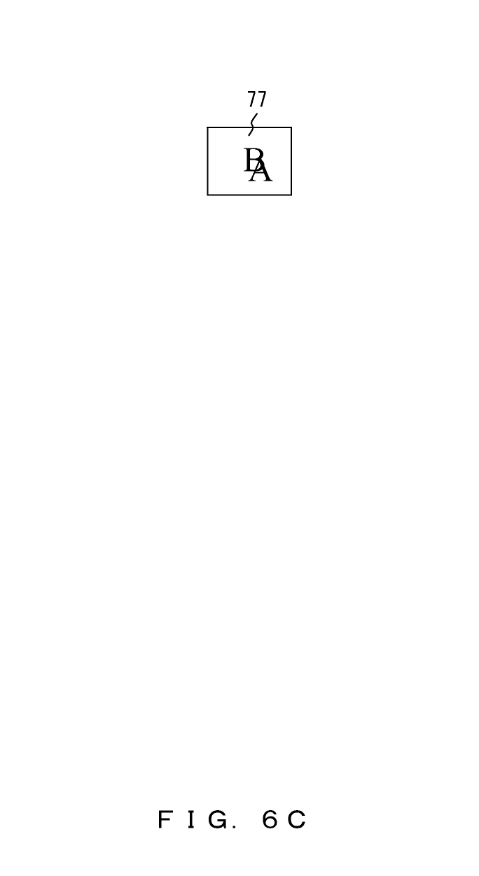

FIG. 6A illustrates an example of part of a configuration of an illumination device according to a sixth embodiment. FIG. 6B illustrates an example of a reflective LCOS included in the illumination device according to this embodiment. FIG. 6C illustrates an example of a light pattern that the illumination device according to this embodiment forms on a sample. The illumination device 70 illustrated in FIG. 6A is an illumination device that forms an arbitrary light pattern on the sample 77 by phase-modulating illumination light emitted from a light source, not illustrated, with the reflective LCOS 73 arranged at a position conjugate to a pupil of an objective lens 76.

The illumination light emitted from the light source is split by a splitter 71 as illustrated in FIG. 6A. The illumination lights are respectively phase-modulated in different areas (areas R1 and R2) on the reflective LCOS 73 illustrated in FIG. 6B via AOTFs (AOTFs 72a and 72b). The illumination lights respectively modulated in the areas are coupled by a prism 74, and incident to the objective lens 76 via a pupil relay optics system 75. The reflective LCOS 73 and the pupil of the objective lens 76 mutually have an optically conjugate relationship. Accordingly, a phase modulation pattern in the area R1 of the reflective LCOS 73 is projected onto the pupil of the objective lens 76, so that a light pattern obtained by performing the Fourier transform for the phase modulation pattern of the area R1 is formed on the sample 77. Moreover, a phase modulation pattern of the area R2 of the reflective LCOS 73 is projected onto the pupil of the objective lens 76, so that a light pattern obtained by performing the Fourier transform for the phase modulation pattern of the area R2 is formed on the sample 77. Accordingly, a phase modulation pattern corresponding to a character “A” and a phase modulation pattern corresponding to a character “B” are respectively formed in the areas R1 and R2, so that a light pattern where the characters “A” and “B” overlap can be formed on the sample 77 as illustrated in FIG. 6C.

Here, in the illumination device 70 according to this embodiment, the areas R1 and R2 of the reflective LCOS 73 are aligned in an incidence direction of light as illustrated in FIG. 6B. Accordingly, a distance from the area R1 to the pupil of the objective lens 76 is different from that from the area R2 to the pupil of the objective lens 76. Therefore, the prism 74 is arranged so that only the illumination light modulated in the area R1 passes through the inside of the prism 74, whereby compensation is made such that an optical path length from the area R1 to the pupil of the objective lens becomes equal to that from the area R2 to the pupil of the objective lens.

With the illumination device 70, a light pattern irradiated on the sample can be arbitrarily and quickly changed similarly to the illumination device 1 illustrated in FIG. 1. Moreover, the illumination device 70 is similar to the illumination device 1 in that the illumination device 70 can more efficiently use light than in a case where light patterns are controlled by an intensity-modulation type SLM such as a digital mirror device or the like.

Additionally, the areas R1 and R2 are aligned in a proceeding direction of light, so that the optical path of the illumination light modulated in the area R1 and that of the illumination light modulated in the area R2 can be coupled, for example, by the prism illustrated in FIG. 6A. Accordingly, the optical paths can be coupled without using a dichoric mirror using a difference between wavelengths, a PBS using a difference between polarization directions, a half mirror, or the like, so that a loss of the amount of illumination light can be reduced to a minimum.

Also for the illumination device 70, the example where the two areas of the reflective LCOS 73 are projected onto the pupil of the objective lens 76 is described. However, three or more areas of the reflective LCOS 73 may be projected onto the pupil of the objective lens 76.

### Seventh Embodiment

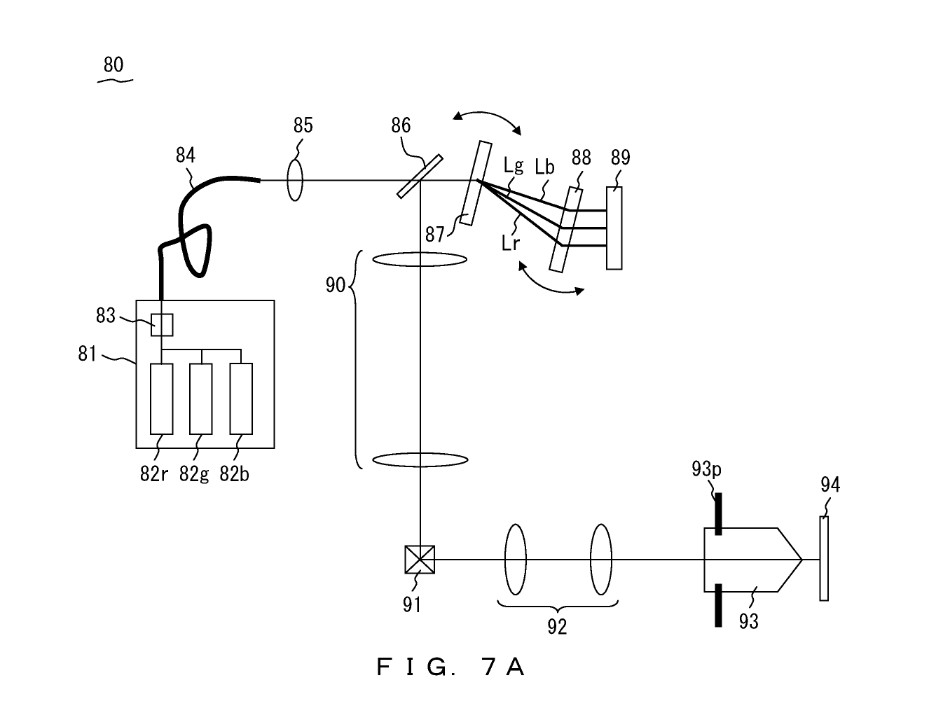

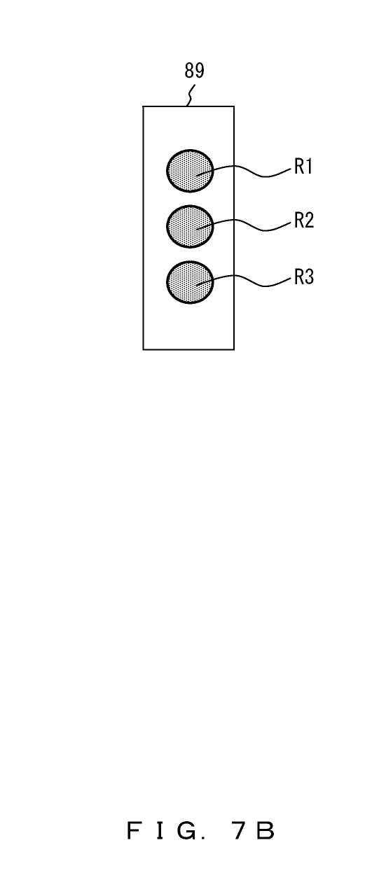

FIG. 7A illustrates an example of a configuration of an illumination device according to a seventh embodiment. FIG. 7B illustrates an example of a reflective LCOS included in the illumination device according to this embodiment. The illumination device 80 illustrated in FIG. 7A is an illumination device that forms an arbitrary light pattern on a sample 94 by phase-modulating laser light emitted from a laser unit 81 with the reflective LCOS 89 arranged at a position conjugate to a pupil of an objective lens 93.

The illumination device 80 includes the laser unit 81 for emitting laser light, an optical fiber 84, a lens 85 for collimating the laser light, a half mirror 86, diffraction gratings 87 and 88 for dispersing the laser light into wavelengths, the reflective LCOS 89 for modulating a phase of the laser light, a pupil relay optics system 90, a galvanomirror 91, which is scanning unit for scanning the sample 94, a pupil relay optics system 92, and an objective lens 93 for irradiating the laser light on the sample 94.

The laser unit 81 includes a plurality of lasers (a laser 82r, a laser 82g, and a laser 82b) for respectively emitting laser lights having different wavelengths, and an AOTF 83 for selectively transmitting the laser lights emitted from the plurality of lasers.

Here, a pupil position 93p of the objective lens 93, the galvanomirror 91, and the reflective LCOS 89 mutually have an optically conjugate relationship. Namely, in the illumination device 80, the pupil relay optics system 90 is configured to project the reflective LCOS 89 onto the galvanomirror 91, and the pupil relay optics system 92 is configured to project the galvanomirror 91 onto the pupil of the objective lens 93.

The diffraction gratings 87 and 88 are means for splitting the laser light so as to irradiate the laser light on a plurality of different areas (areas R1, R2, and R3 illustrated in FIG. 7B) within the reflective LCOS 89. Moreover, the diffraction gratings 87 and 88 are optical path coupling units, arranged between the reflective LCOS 89 and the objective lens 93, for coupling optical paths of the laser lights respectively modulated in the plurality of areas (the areas R1, R2, and R3) of the reflective LCOS 89, and are light coupling units for coupling the laser lights respectively modulated in the plurality of areas (the areas R1, R2, and R3). The diffraction gratings 87 and 88 may be, for example, VPH (Volume Phase Holographic) gratings arranged to freely rotate so as to change an incidence angle of the laser light. If the diffraction gratings 87 and 88 are VPH gratings, use efficiency of light can be improved by optimizing the incidence angle of the laser light according to a wavelength of the laser light.

The reflective LCOS 89 is a phase-modulation type SLM, arranged at a position optically conjugate to the pupil position 93p between the laser unit 81 and the objective lens 93, for modulating a phase of incident light, and has a pixel structure composed of a plurality of pixels each of which independently modulates the phase of the incident light.

The galvanomirror 91 is scanning unit for two-dimensionally scanning the sample 94 on an XY plane orthogonal to the optical axis of the objective lens 93. For example, an acoustic optical deflector (AOD) or the like may be used instead of the galvanomirror 91.

The pupil relay optics system 90 and the pupil relay optics system 92 are optics systems for projecting a pupil plane of the objective lens 93 onto the reflective LCOS 89. By adding the diffraction gratings 87 and 88, which are optical path coupling units, the pupil of the objective lens 93 is respectively projected onto the areas R1, R2, and R3 of the reflective LCOS 89. Namely, the diffraction grating 87, the diffraction grating 88, the pupil relay optics system 90, and the pupil relay optics system 92 are a pupil projecting optics system for projecting the pupil of the objective lens 93 onto the plurality of different areas (the areas R1, R2, and R3) of the reflective LCOS 89.

The AOTF 83 within the laser unit 81 is intensity modulation unit for modulating intensities, on the sample 94, of lights respectively modulated in the plurality of areas of the reflective LCOS 89, and is wavelength selection unit for selecting a wavelength of the light irradiated on the sample 94. Accordingly, the AOTF 83 can independently deflect or shut off the lights respectively modulated in the plurality of areas of the reflective LCOS 89.

In the illumination device 80 configured as described above, laser light emitted from the laser unit 81 is collimated by the lens 85 to which the light is incident via the optical fiber 84, passes through the half mirror 86, and is incident to the diffraction grating 87. The diffraction grating 87 disperses the laser light into wavelengths such as laser light Lr having a red wavelength, laser light Lg having a green wavelength, and laser light Lb having a blue wavelength. The laser light Lr, the laser light Lg, and the laser light Lb, into which the laser light is dispersed, are deflected by the diffraction grating 88 in a direction vertical to the reflective LCOS 89, and respectively modulated in the area R1, the area R2, and the area R3. The laser lights respectively modulated in the area R1, the area R2, and the area R3 proceed on the same path in a reverse direction, and are coupled by the diffraction gratings 88 and 87. The coupled laser light is reflected on the half mirror 86, and incident to the objective lens 93 via the pupil relay optics system 90, the galvanomirror 91, and the pupil relay optics system 92. The objective lens 93 forms, on the sample 94, a light pattern obtained by performing a Fourier transform for a phase modulation pattern formed in the area R1 from the laser light phase-modulated in the area R1, also forms, on the sample 94, a light pattern obtained by performing a Fourier transform for a phase modulation pattern formed in the area R2 from the laser light phase-modulated in the area R2, and further forms, on the sample 94, a light pattern obtained by performing a Fourier transform a the phase modulation pattern formed in the area R3 from the laser light phase-modulated in the area R3.

In the illumination device 80, a total of 7 (=₃C₁+₃C₂+₃C₃) states are switched by arbitrarily controlling irradiation of the laser lights on the areas R1 to R3 with a control of the AOTF 83, and a light pattern according to each of the states is formed on the sample 94.

With the illumination device 80, a light pattern irradiated on the sample can be more arbitrarily and quickly changed than the illumination device 1 illustrated in FIG. 1 and the illumination device 20 illustrated in FIG. 2.

In the illumination device 80, the diffraction gratings 87 and 88 split the laser light into wavelengths, and couple reflected laser lights. Therefore, a lot more areas of the reflective LCOS 89 can be projected onto the pupil of the objective lens 93 only by increasing wavelengths of the laser lights without changing the configuration of the device. Moreover, in the illumination device 80, a wavelength to be used of light can be arbitrarily selected, and also a difference among optical path lengths of wavelengths of light can be reduced to a minimum.

### Eighth Embodiment

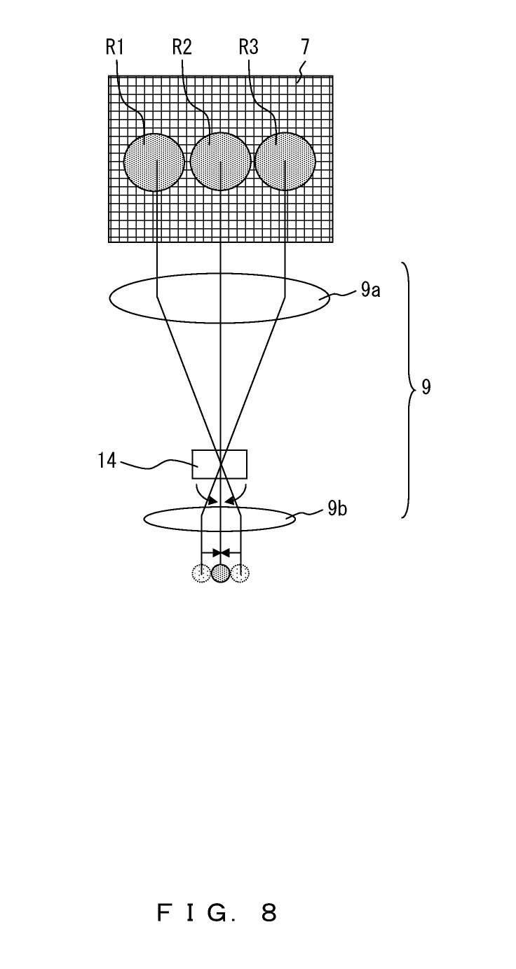

FIG. 8 illustrates an example of part of a configuration of an illumination device according to an eighth embodiment.

The illumination device illustrated in FIG. 8 is an illumination device implemented by removing the optical elements arranged between the reflective LCOS 7 and the pupil relay optics system 9 from the illumination device 1 illustrated in FIG. 1, and by adding an acoustic optical deflector (AOD) 14 between the lens 9a and the lens 9b.

The AOD 14 functions as an optical deflector for deflecting light modulated in one area selected from among a plurality of areas (areas R1, R2 and R3) of the reflective LCOS 7 toward the pupil of the objective lens 12. Namely, the AOD 14 functions as optical path coupling unit for coupling optical paths of illumination lights respectively modulated in the plurality of areas of the reflective LCOS 7 by sequentially orientating the optical paths of the illumination lights from the areas toward an optical axis direction of the lens 9b. Note that a galvanomirror may be used instead of the AOD 14.

In the illumination device configured as described above, the illumination lights respectively modulated in the different areas of the reflective LCOS 7 are collected on the AOD 14 by the lens 9a. Therefore, the areas of the reflective LCOS 7 projected onto the pupil of the objective lens 12 can be arbitrarily switched by controlling the deflection direction of the illumination lights by the AOD 14. Accordingly, also with the illumination device according to this embodiment, a light pattern irradiated on the sample can be arbitrarily and quickly changed.

Additionally, in the illumination device according to this embodiment, the configuration of the optical path coupling unit does not need to be changed even when a lot more areas of the reflective LCOS 7 are projected onto the pupil of the objective lens 12. Therefore, similarly to the illumination device 80 according to the seventh embodiment, the illumination device according to this embodiment is especially preferable in a case where many areas of a phase-modulation type SLM are projected onto a pupil of an objective lens.

### Ninth Embodiment

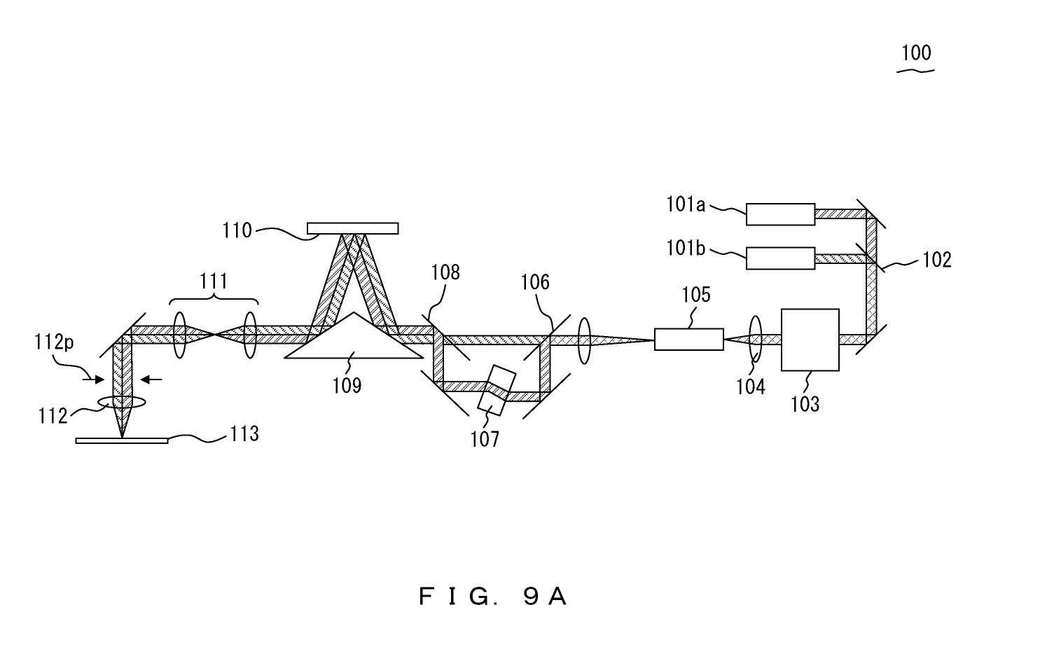

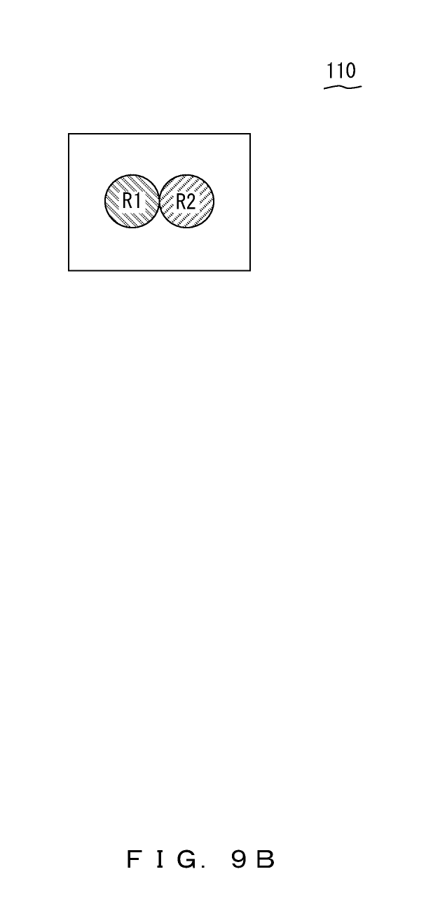

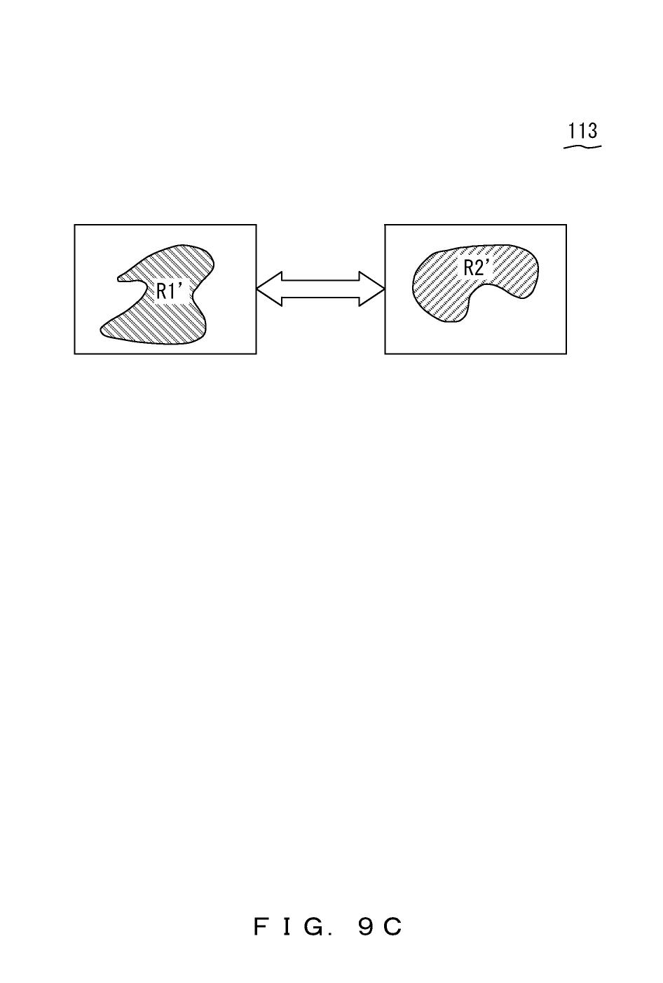

FIG. 9A illustrates an example of a configuration of an illumination device according to a ninth embodiment. FIG. 9B illustrates an example of a reflective LCOS included in the illumination device according to this embodiment. FIG. 9C illustrates an example of light patterns formed on a sample by the illumination device according to this embodiment. The illumination device 100 illustrated in FIG. 9A is an illumination device that forms an arbitrary light pattern on the sample 113 by phase-modulating laser lights emitted from lasers (a laser 101a and a laser 101b) with the reflective LCOS 110 arranged at a position conjugate to a pupil of an objective lens 112.

The illumination device 100 includes the laser 101a, the laser 101b, a dichroic mirror 102, an AOTF 103, a coupling lens 104, the optical fiber 105, the dichroic mirror 106, a shifter 107 for shifting the laser light in parallel in a direction orthogonal to an optical axis, a dichroic mirror 108, a prism 109, a reflective LCOS 110, a pupil relay optics system 111, and the objective lens 112.

Here, a pupil position 112p of the objective lens 112 and the reflective LCOS 110 mutually have an optically conjugate relationship. Namely, in the illumination device 100, the pupil relay optics system 111 is configured to project the reflective LCOS 110 onto the pupil of the objective lens 112.

In the illumination device 100 configured as described above, the laser light emitted from the laser 101a and that emitted from the laser 101b are incident to the AOTF 103 after being coupled by the dichroic mirror 102. The AOTF 103 is intensity modulation unit for modulating intensities, on the sample 113, of the lights modulated respectively in the plurality of areas (the areas R1 and R2 of FIG. 9B) of the reflective LCOS 110, and is wavelength selection unit. Accordingly, the lights respectively modulated in the plurality of areas of the reflective LCOS 110 are independently deflected or shut off by the AOTF 103.

The laser light that has passed through the AOTF 103 is incident to the dichroic mirror 106 via the coupling lens 104 and the optical fiber 105. The dichroic mirror 106 splits the laser light emitted from the laser 101a and that emitted from the laser 101b into wavelengths. The laser light that has passed through the dichroic mirror 106 passes through the dichroic mirror 108 unchanged, whereas the laser light that has been reflected on the dichroic mirror 106 is shifted in parallel by the shifter 107 in the direction orthogonal to the optical axis. Accordingly, the laser light emitted from the laser 101a and that emitted from the laser 101b are irradiated on the different areas (the area R1 and the area R2) of the reflective LCOS 110 as illustrated in FIG. 9B.

The different areas of the reflective LCOS 110 are projected by the pupil relay optics system 111 on different areas of the pupil of the objective lens 112. Namely, the pupil relay optics system (pupil projecting optics system) is configured to project a plurality of areas within the pupil of the objective lens 112 onto a plurality of areas of the reflective LCOS 110. Accordingly, as illustrated in FIG. 9C, the objective lens 112 forms, on the sample 113, a light pattern R1′ obtained by performing a Fourier transform for a phase modulation pattern formed in the area R1 from the illumination light phase-modulated in the area R1, and also forms, on the sample 113, a light pattern R2′ obtained by performing a Fourier transform for a phase modulation pattern formed in the area R2 from the illumination light phase-modulated in the area R2.

Accordingly, in the illumination device 100, a state (first state) where the laser light is irradiated only on the area R1, a state (second state) where the laser light is irradiated only on the area R2, and a state (third state) where the laser light is irradiated on both of the areas R1 and R2 are switched by controlling the AOTF 103, and also a light pattern on the sample 113 is switched. Specifically, the light pattern obtained by performing the Fourier transform for the phase modulation pattern formed in the area R1 is formed on the sample 113 in the first state, the light pattern obtained by performing the Fourier transform for the phase modulation pattern formed in the area R2 is formed on the sample 113 in the second state, and a pattern where the light pattern obtained by performing the Fourier transform for the phase modulation pattern formed in the area R1 and that obtained by performing the Fourier transform for the phase modulation pattern formed in the area R2 overlap is formed on the sample 113.

With the illumination device 100, a light pattern irradiated on the sample can be arbitrarily and quickly changed. Also in the illumination device 100, the light patterns are controlled by the reflective LCOS 110, which is a phase-modulation type SLM. Therefore, light can be more efficiently used than in a case where light patterns are controlled by an intensity-modulation type SLM such as a digital mirror device or the like. Additionally, the optical path coupling unit is not needed between the reflective LCOS 110 and the objective lens 112 unlike the first to the eighth embodiments. Therefore, light patterns irradiated on the sample can be arbitrarily and quickly changed with a simpler configuration.

For the illumination device 100, the example where the two areas of the reflective LCOS 110 are projected onto corresponding two areas within the pupil of the objective lens 112 is described. However, three or more areas of the reflective LCOS 110 can be projected onto corresponding areas within the pupil of the objective lens 112.

### Tenth Embodiment

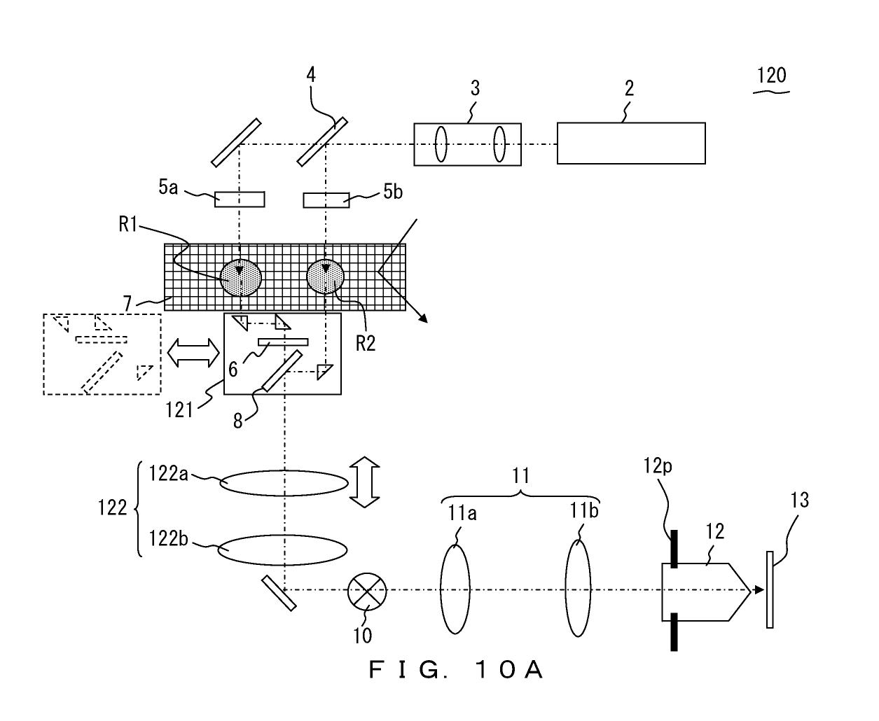

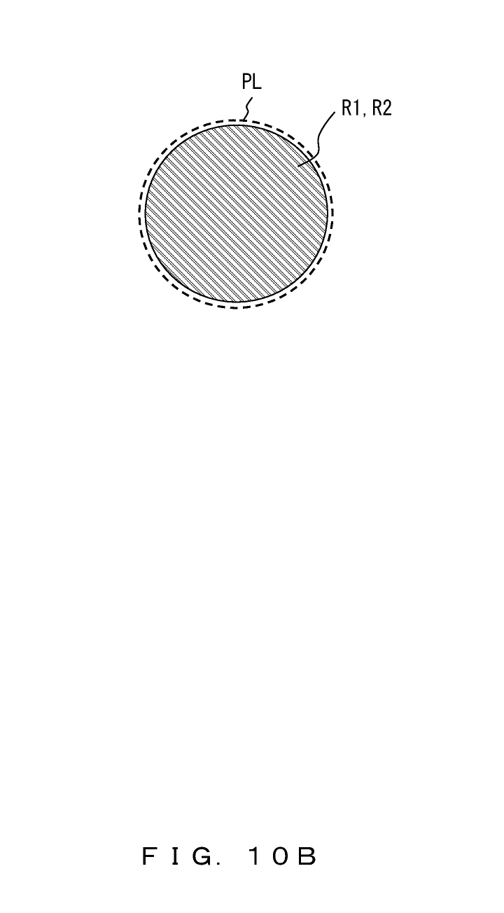

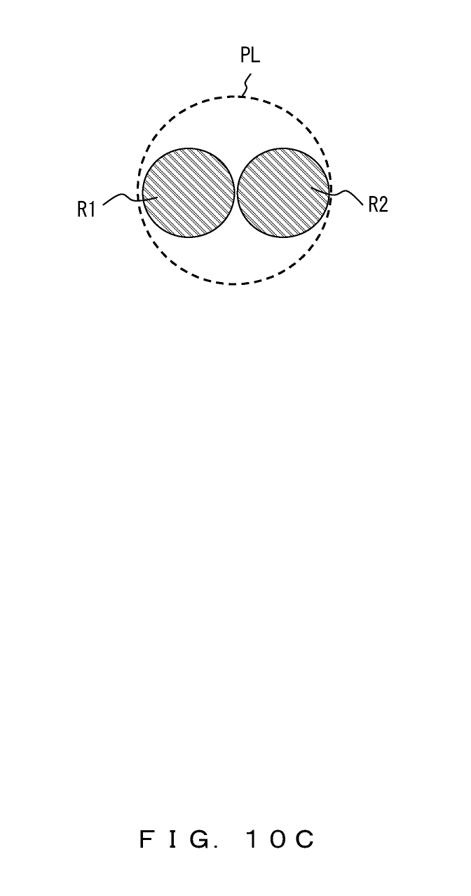

FIG. 10A illustrates an example of a configuration of an illumination device according to a tenth embodiment. FIGS. 10B and 10C respectively illustrate a state of light incident to a pupil of an objective lens when optical path coupling unit included in the illumination device according to this embodiment is inserted to or removed from an optical path. The illumination device 120 illustrated in FIG. 10A is different from the illumination device 1 illustrated in FIG. 1 in that optical path coupling unit 121 (the PBS 8, the λ/2 plate 6, and the plurality of prisms) is arranged to be freely insertable/removable to/from the optical path and a pupil relay optics system 122 is included instead of the pupil relay optics system 9. Other components are similar to those of the illumination device 1 illustrated in FIG. 1. In FIG. 10A, the same components as those of the illumination device 1 are denoted with the same reference numerals.

The pupil relay optics system 122 is configured as an afocal zoom optics system. At least either of lenses 122a and 122b (lens 122a in FIG. 10A), which configure the pupil relay optics system 122, moves in an optical axis direction, so that a pupil projection magnification can be changed.

In the illumination device 120, areas R1 and R2 of the reflective LCOS 7 are respectively projected to overlap within a pupil PL of the objective lens 12 as illustrated in FIG. 10B by adjusting the pupil projection magnification of the pupil relay optics system when the optical path coupling unit 121 is inserted to the optical path, whereas the area R1 and the area R2 of the reflective LCOS 7 are respectively projected onto different areas within the pupil PL of the objective lens 12 as illustrated in FIG. 10C by adjusting the pupil projection magnification of the pupil relay optics system when the optical path coupling unit 121 is removed from the optical path.

Accordingly, with the illumination device 120, a configuration similar to that of the illumination device 1 according to the first embodiment for projecting the pupil of the objective lens onto a plurality of areas of the phase-modulation type SLM, and a configuration similar to that of the illumination device 100 according to the ninth embodiment for projecting a plurality of areas within the pupil of the objective lens onto a plurality of areas of the phase-modulation type SLM can be easily switched by inserting/removing the optical path coupling unit 121.

Note that a pupil relay optics system having a different projection magnification may be included instead of the pupil relay optics system 122, and a replacement may be made with a pupil relay optic system having a different projection magnification the same time the optical path coupling unit 121 is inserted/removed.

As referred to in the first to the tenth embodiments, an illumination device and a microscope apparatus, which include a phase-modulation type SLM arranged at a position optically conjugate to a pupil position of an illumination lens, can arbitrarily and quickly change a light pattern irradiated on a sample by including a pupil projection optics system for projecting at least one area within a pupil of the illumination lens onto a plurality of different areas of the phase-modulation type SLM.

What is claimed is:

1. An illumination device, comprising:
a phase-modulation type spatial light modulator that is arranged at a position optically conjugate to a pupil position of an illumination lens between a light source and the illumination lens for irradiating light emitted from the light source on a sample; and
a pupil projecting optics system for projecting at least one area within a pupil of the illumination lens onto a plurality of different areas of the spatial light modulator.

2. The illumination device according to claim 1, wherein
the pupil projecting optics system is configured to project the pupil of the illumination lens onto the plurality of areas of the spatial light modulator.

3. The illumination device according to claim 2, wherein
the pupil projecting optics system includes optical path coupling unit, arranged between the spatial light modulator and the illumination lens, for coupling optical paths of lights respectively modulated in the plurality of areas of the spatial light modulator.

4. The illumination device according to claim 1, wherein
the pupil projecting optics system is configured to project the plurality of areas within the pupil of the illumination lens onto the plurality of areas of the spatial light modulator.

5. The illumination device according to claim 2, further comprising
intensity modulation unit for modulating intensities, on the sample, of the lights respectively modulated in the plurality of areas of the spatial light modulator.

6. The illumination device according to claim 5, wherein
the intensity modulation unit independently deflects or shuts off lights to be respectively modulated or the lights respectively modulated in the plurality of areas of the spatial light modulator.

7. The illumination device according to claim 5, wherein
the intensity modulation unit comprises a plurality of intensity modulation elements made to respectively correspond to the plurality of areas of the spatial light modulator, and
each of the plurality of intensity modulation elements deflects or shuts off light to be modulated or the light modulated in a corresponding area among the plurality of areas.

8. The illumination device according to claim 5, wherein
the intensity modulation unit is a light deflector for deflecting the light modulated in one area selected among the plurality of areas of the spatial light modulator toward the pupil of the illumination lens.

9. The illumination device according to claim 5, further comprising
wavelength selection unit for selecting a wavelength of light irradiated on the sample.

10. The illumination device according to claim 9, wherein
the intensity modulation unit is the wavelength selection unit.

11. The illumination device according to claim 9, wherein
each of a plurality of lights having different wavelength emitted from the light source are incident to a corresponding area among the plurality of areas of the spatial light modulator.

12. A microscope apparatus, comprising:
an illumination lens; and
the illumination device according to claim 1.
